(19) United States
(12) Patent Application Publication
(10) Pub. No.: US 2011/0313569 A1
(43) Pub. Date: Dec. 22, 2011

(54) Transferring Storage Devices within Storage Device Testing Systems

(75) Inventor: Dennis Lafosse, Boston, MA (US)

(73) Assignee: Teradyne, Inc.

(21) Appl. No.: 12/817,380

(22) Filed: Jun. 17, 2010

(51) Int. Cl. B25J 9/00

(52) U.S. Cl. 700/245

(57) ABSTRACT

A method of transferring storage devices within a storage device testing system includes receiving storage device information of storage devices presented for testing, querying at least one rack having test slots to obtain test slot servicing information, determining a servicing routine based on the storage device information and the test slot servicing information, and producing a command routine for executing the servicing routine. The command routine includes a sequence of automation moves for execution by an automated transporter. Producing the command routine includes executing at least one of a time-based enhancement and a sequence-based enhancement on the command routine. The time-based enhancement includes selecting a second automation move based on a start location of the second automation move and an end location of a sequentially preceding first automation move. The sequence-based enhancement includes producing a reduced sequence of automation moves for one or more storage device transfers.

### TECHNICAL FIELD

This disclosure relates to transferring storage devices within storage device testing systems.

### BACKGROUND

Storage device manufacturers typically test manufactured storage devices for compliance with a collection of requirements. Test equipment and techniques exist for testing large numbers of storage devices serially or in parallel. Manufacturers tend to test large numbers of storage devices simultaneously. Storage device testing systems typically include one or more racks having multiple test slots that receive storage devices for testing. Some automated storage device testing systems use a robot or other automated transporter to move storage devices in and out of the test slots.

Current automated storage device testing systems use an operator, a robotic arm, or a conveyer belt to individually feed disk drives to a transfer location for loading into the testing system for testing. An automated transporter individually retrieves the storage devices from the transfer location and loads them in test slots for testing.

### SUMMARY

One aspect of the disclosure provides a method of transferring storage devices within a storage device testing system. The method includes maintaining storage device information of storage devices presented for testing or that have completed some stage of testing, querying at least one rack having test slots to obtain test slot servicing information, and determining a servicing routine based on the storage device information and the test slot servicing information. The servicing routine includes storage device transfers for transferring storage devices between first and second locations. The method also includes producing a command routine for executing the servicing routine. The command routine comprises a sequence of automation moves for execution by an automated transporter configured to handle one or more storage devices during a single automation move. The method includes executing the command routine on the automated transporter. Producing the command routine includes executing at least one of a time-based enhancement and a sequence-based enhancement on the command routine. The time-based enhancement includes selecting a second automation move based on a start location of the second automation move and an end location of a sequentially preceding first automation move. The sequence-based enhancement includes producing a reduced sequence of automation moves for one or more storage device transfers.

Another aspect of the disclosure provides a storage device testing system that includes a controller, an automated transporter in communication with the controller, racks arranged for access by the automated transporter, and test slots housed by each rack. Each test slot is configured to receive a storage device for testing. The automated transporter is configured to handle one or more storage devices during a single automation move. The storage device testing system also includes a transfer station arranged for access by the automated transporter. The transfer station presents storage devices for testing. The controller is configured to receive storage device information of storage devices presented for testing, query at least one rack to obtain test slot servicing information, and determine a servicing routine based on the storage device information and the test slot servicing information. The servicing routine includes storage device transfers for transferring storage devices between first and second locations. The controller is also configured to produce a command routine for executing the servicing routine and execute the command routine on the automated transporter. The command routine includes a sequence of automation moves for execution by the automated transporter. Producing the command routine includes executing at least one of a time-based enhancement and a sequence-based enhancement on the command routine. The time-based enhancement includes selecting a second automation move based on a start location of the second automation move and an end location of a sequentially preceding first automation move. The sequence-based enhancement includes producing a reduced sequence of automation moves for one or more storage device transfers.

Implementations of the disclosure may include one or more of the following features. In some implementations, executing the time-based enhancement on the command routine includes selecting the second automation move based a travel time of the automated transporter between the start location of the second automation move and the end location of a preceding first automation move. Executing the time-based enhancement on the command routine may include arranging a set of one or more automation moves of a first storage device transfer to be sequentially adjacent a set of one or more automation moves of a second storage device transfer. In some examples, the first storage device transfer comprises moving a first storage device between a first test slot and a first presentation location, and the second storage device transfer comprises moving a second storage device between a second presentation location and a second test slot. The first and second test slots may be the same test slot. The first and second presentation locations may be the same presentation locations (e.g., the same tote receptacle). In other examples, the first storage device transfer comprises moving a first storage device between a first test slot and a second test slot, and the second storage device transfer comprises moving a second storage device between the second test slot and a presentation location.

In some implementations, executing the sequence-based enhancement on the command routine includes producing a fixed sequence of automation moves for a combination of two or more storage device transfers. Executing the sequence-based enhancement on the command routine may include producing a combined automation move that replaces a sequentially first automation move and a sequentially second automation move. In some examples, the sequentially first automation move comprises depositing an empty first storage device transporter and the sequentially second automation move comprises retrieving an empty second storage device transporter for retrieving a storage device. The combined automation move includes using the first storage device transporter to retrieve the storage device.

In some implementations, the servicing routine includes a first storage device transfer comprising moving a first storage device between a first test slot and a first presentation location, and a second storage device transfer comprising moving a second storage device between a second presentation location and a second test slot. For this servicing routine, the sequence-based enhancement of the command routine may include retrieving a storage device transporter carrying the first storage device from the first test slot, depositing the first storage device at the first presentation location, retrieving the second storage device from the second presentation location with the empty storage device transporter, and depositing the storage device transporter carrying the second storage device in the second test slot. The first and second test slots may be the same test slot. The first and second presentation locations may be the same presentation location. In some cases, the first and second presentation locations include one or more tote receptacles of a tote. Each of the tote receptacles is configured to receive a storage device. In some examples, the first and second presentation locations are the same tote receptacle.

For a servicing routine that includes a first storage device transfer comprising moving a first storage device between a first test slot and a second test slot, a second storage device transfer comprising moving a second storage device between the second test slot and a first presentation location, and a third storage device transfer comprising moving a third storage device from a second presentation location to the first test slot, the sequence-based enhancement of the command routine may include the following automation moves: retrieving a first storage device transporter carrying the first storage device from the first test slot; depositing the first storage device at a staging location; retrieving the third storage device from the second presentation location with the empty first storage device transporter; depositing the first storage device transporter carrying the third storage device in the first test slot; retrieving a second storage device transporter carrying the second storage device from the second test slot; depositing the second storage device at the second presentation location; retrieving the first storage device from the staging location with the empty second storage device transporter; and depositing the second storage device transporter carrying the first storage device in the second test slot. In some examples, The first and second presentation locations may be the same presentation location. In some cases, the first and second presentation locations include one or more tote receptacles of a tote. Each of the tote receptacles is configured to receive a storage device. In some examples, the first and second presentation locations are the same tote receptacle.

For a servicing routine that includes a first storage device transfer comprising moving a first storage device between a first test slot and a second test slot and a second storage device transfer comprising moving a second storage device between the second test slot and a presentation location, the sequence-based enhancement of the command routine may include: retrieving a first storage device transporter carrying the first storage device from the first test slot; depositing the first storage device at a staging location; depositing the empty first storage device transporter in the first test slot; retrieving a second storage device transporter carrying the second storage device from the second test slot; depositing the second storage device at the presentation location; retrieving the first storage device from the staging location with the empty second storage device transporter; and depositing the second storage device transporter carrying the first storage device in the second test slot. In some examples, the presentation location includes a tote receptacle configured to receive a storage device.

The details of one or more implementations of the disclosure are set forth in the accompanying drawings and the description below. Other features, objects, and advantages will be apparent from the description and drawings, and from the claims.

### DESCRIPTION OF DRAWINGS

FIG. 1 is a perspective view of a storage device testing system having racks arranged in a substantially circular configuration.

FIG. 2 is a top view of the storage device testing system shown in FIG. 1.

FIG. 3 is a perspective view of a storage device testing system and a transfer station.

FIGS. 4A and 4B are perspective views of a storage device transporter carrying a storage device being received inserted into a test slot of a storage device testing system.

FIG. 4C is a sectional view of a test slot along line 4C-4C in FIG. 4A.

FIG. 4D is a perspective view of a test slot and a test slot cooling system in a rack of a storage device testing system.

FIG. 5A is a side perspective view of a storage device transporter.

FIG. 5B is a front perspective view of a storage device transporter.

FIG. 5C is a bottom perspective view of a storage device transporter.

FIG. 5D is a perspective view of a storage device transporter receiving a storage device.

FIG. 6A is a perspective view of a tote with storage device receptacles.

FIG. 6B is a perspective view of a tote receiving a storage device in a storage device receptacle.

FIG. 7A is a perspective view of a manipulator for a robotic arm having first and second manipulator arms.

FIG. 7B is a bottom perspective view of the manipulator shown in FIG. 7A.

FIG. 8 is a flow chart providing an exemplary arrangement for transferring storage devices within a storage device testing system.

FIG. 9 is a schematic of automation moves for executing a non-enhanced and an enhanced command routine for a rack-to-tote and tote-to-rack combination automation move.

FIG. 10 is a schematic of automation moves for executing a non-enhanced command routine for a rack-to-rack move combined with a rack-to-tote and tote-to-rack combination automation move.

FIG. 11 is a schematic of automation moves for executing an enhanced command routine for a rack-to-rack move combined with a rack-to-tote and tote-to-rack combination automation move.

FIG. 12 is a schematic of automation moves for executing a non-enhanced command routine for a rack-to-rack and rack-to-tote combination automation move.

FIG. 13 is a schematic of automation moves for executing an enhanced command routine for a rack-to-rack and rack-to-tote combination automation move.

Like reference symbols in the various drawings indicate like elements.

### DETAILED DESCRIPTION

Bulk feeding of storage devices in a storage device testing system is advantageous over manual individual feeding of storage devices by providing increased through-put and efficiency of the storage device testing system, inter alia. As will be discussed in detail, presenting multiple storage device totes (also referred to as totes), which hold multiple storage devices, to a storage device testing system allows continual storage device testing, sorting amongst multiple storage device totes, minimal user intervention, and increased efficiency over current systems, inter alia. Bulk feeding of storage devices in storage device totes provides the advantage of shop floor flexibility (e.g., by providing the ability to easily redirect a storage device tote or a cart or trolley carrying storage device totes versus rerouting fixed conveyors). An operator can present a batch of drives (e.g., via the storage device tote) to the storage device testing system and then walk away to service another system. Bulk feeding of storage devices in storage device totes also allows automatic sorting of tested drives with the storage device totes.

A storage device, as used herein, includes disk drives, solid state drives, memory devices, and any device that benefits from asynchronous testing for validation. A disk drive is generally a non-volatile storage device which stores digitally encoded data on rapidly rotating platters with magnetic surfaces. A solid-state drive (SSD) is a data storage device that uses solid-state memory to store persistent data. An SSD using SRAM or DRAM (instead of flash memory) is often called a RAM-drive. The term solid-state generally distinguishes solid-state electronics from electromechanical devices.

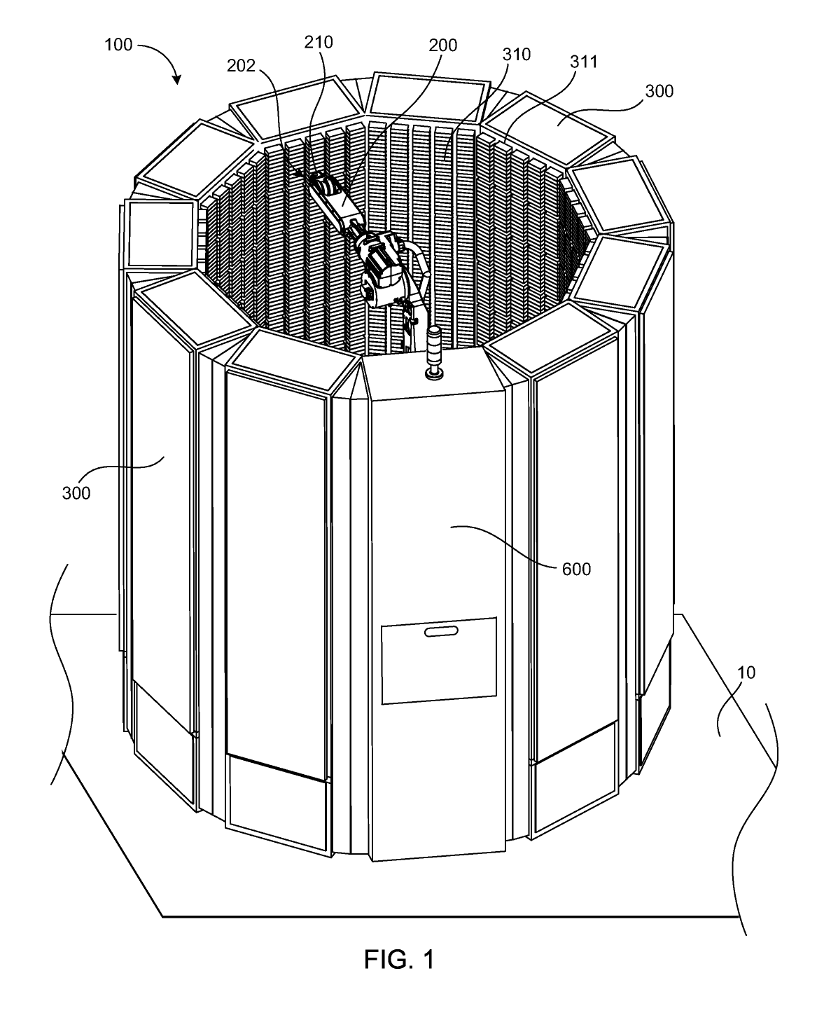

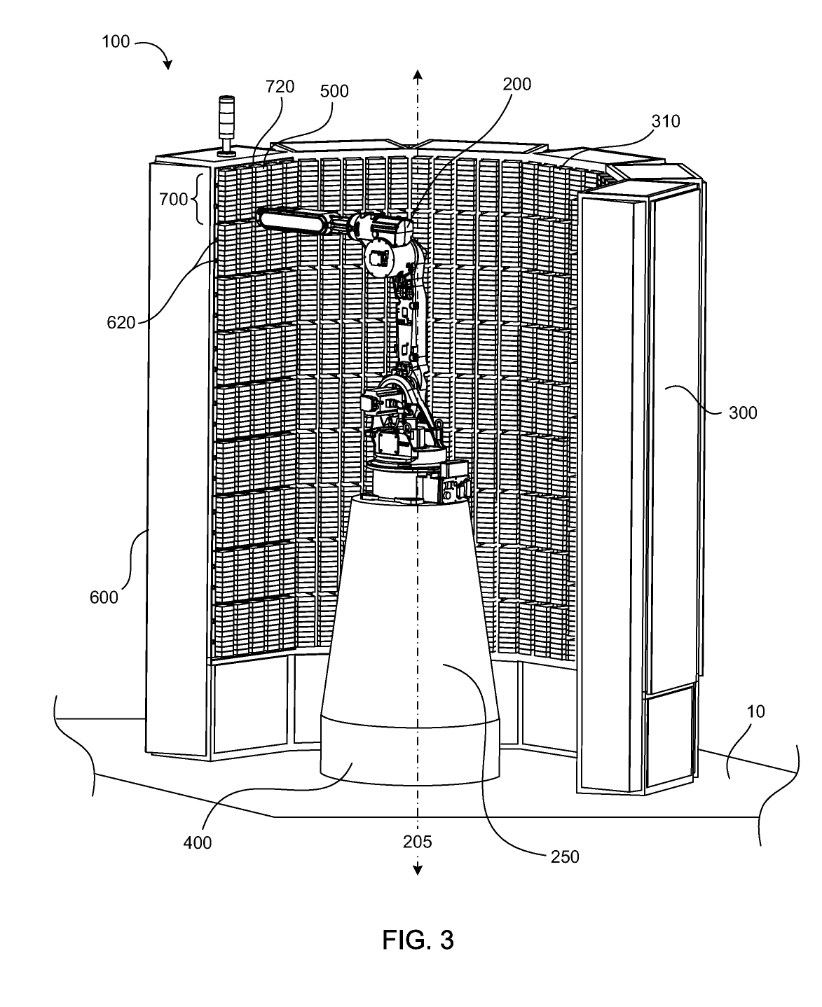

Referring to FIGS. 1-3, in some implementations, a storage device testing system 100 includes at least one automated transporter 200 (e.g. robotic arm, gantry system, or multi-axis linear actuator) defining a first axis 205 (see FIG. 3) substantially normal to a floor surface 10. In the examples shown, the automated transporter 200 comprises a robotic arm 200 operable to rotate through a predetermined arc about the first axis 205 and to extend radially from the first axis 205. The robotic arm 200 is operable to rotate at least 360° about the first axis 205 and includes a manipulator 210 disposed at a distal end 202 of the robotic arm 200 to handle one or more storage devices 500 and/or storage device transporters 550 to carry the storage devices 500. Multiple racks 300 are arranged around the robotic arm 200 for servicing by the robotic arm 200. Each rack 300 houses multiple test slots 310 configured to receive storage devices 500 for testing. In some implementations, the robotic arm 200 defines a substantially cylindrical working envelope volume 220, with the racks 300 being arranged within the working envelope 220 for accessibility of each test slot 310 for servicing by the robotic arm 200. The substantially cylindrical working envelope volume 220 provides a compact footprint and is generally only limited in capacity by height constraints. In some examples, the robotic arm 200 is elevated by and supported on a pedestal 250 on the floor surface 10. The pedestal 250 increases the size of the working envelope volume 220 by allowing the robotic arm 200 to reach not only upwardly, but also downwardly to service test slots 310. A controller 400 (e.g., computing device) communicates with each automated transporter 200 and racks 300. The controller 400 coordinates servicing of the test slots 310 by the automated transporter(s) 200.

The robotic arm 200 is configured to independently service each test slot 310 to provide a continuous flow of storage devices 500 through the testing system 100. A continuous flow of individual storage devices 500 through the testing system 100 allows different start and stop times for each storage device 500, whereas other systems that require batches of storage devices 500 to be run all at once as an entire testing loaded must all have the same start and end times. Therefore, with continuous flow, storage devices 500 of different capacities can be run at the same time and serviced (loaded/unloaded) as needed.

Referring to FIG. 3, the storage device testing system 100 includes a transfer station 600 configured for bulk feeding of storage devices 500 to the robotic arm 200. The robotic arm 200 independently services each test slot 310 by transferring a storage device 500 between the transfer station 600 and the test slot 310. The transfer station 600 houses one or more totes 700 carrying multiple storage devices 500 presented for servicing by the robotic arm 200. The transfer station 600 is a service point for delivering and retrieving storage devices 500 to and from the storage device testing system 100. The totes 700 allow an operator to deliver and retrieve a collection of storage devices 500 to and from the transfer station 600. In the example shown in FIG. 3, each tote 700 is accessible from respective tote presentation support systems 620 in a presentation position and may be designated as a source tote 700 for supplying a collection of storage devices 500 for testing or as a destination tote 700 for receiving tested storage devices 500 (or both). Destination totes 700 may be classified as “passed return totes” or “failed return totes” for receiving respective storage devices 500 that have either passed or failed a functionality test, respectively.

In some implementations, the robotic arm 200 is configured to independently service each test slot 310 to provide a continuous flow of storage devices 500 through the processing system 100. A continuous flow of individual storage devices 500 through the processing system 100 allows varying start and stop times for each storage device 500. Therefore, with continuous flow, storage devices 500 of different capacities can be run at the same time and serviced (e.g., loaded/unloaded) as needed. In other implementations, the processing system 100 tests batches of storage devices 500 all at once, where an entire batch of loaded storage devices start and end at substantially the same time.

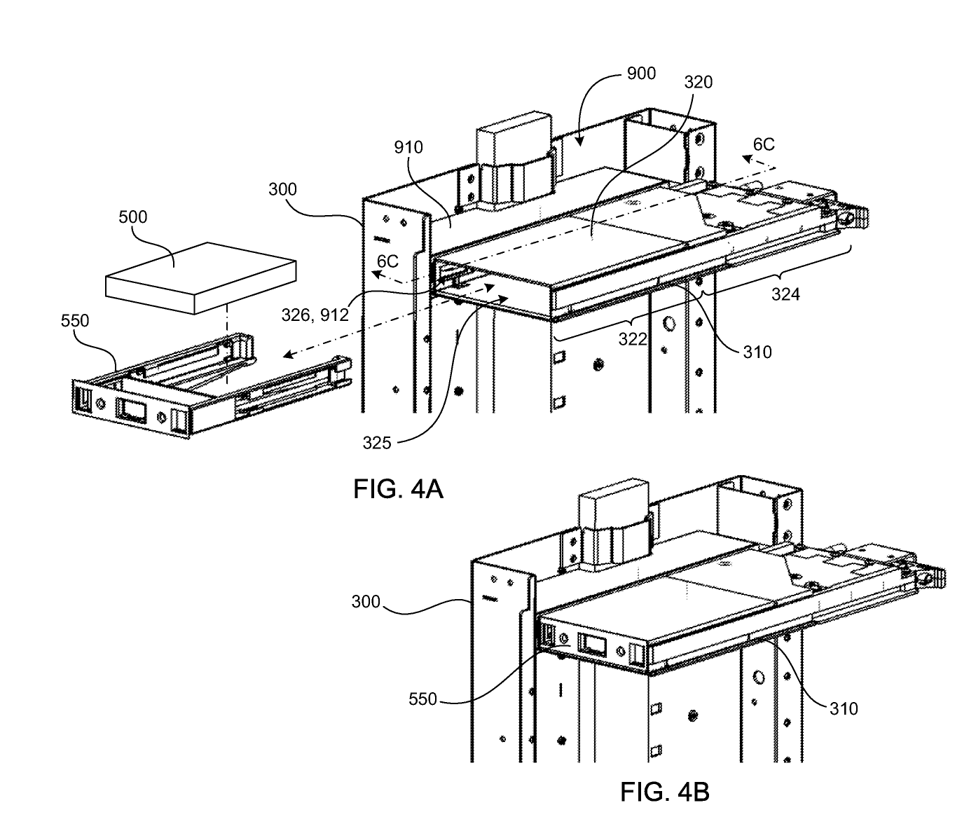

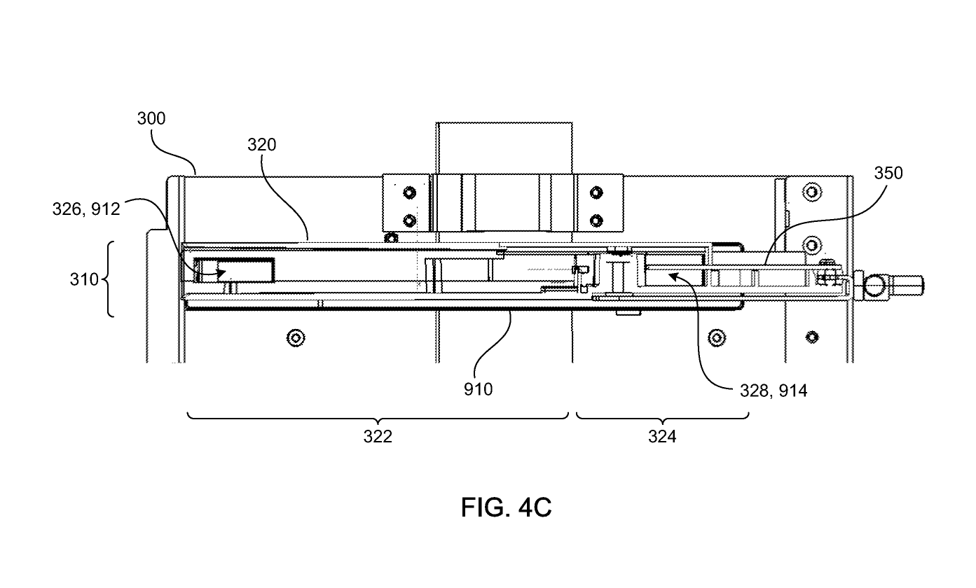

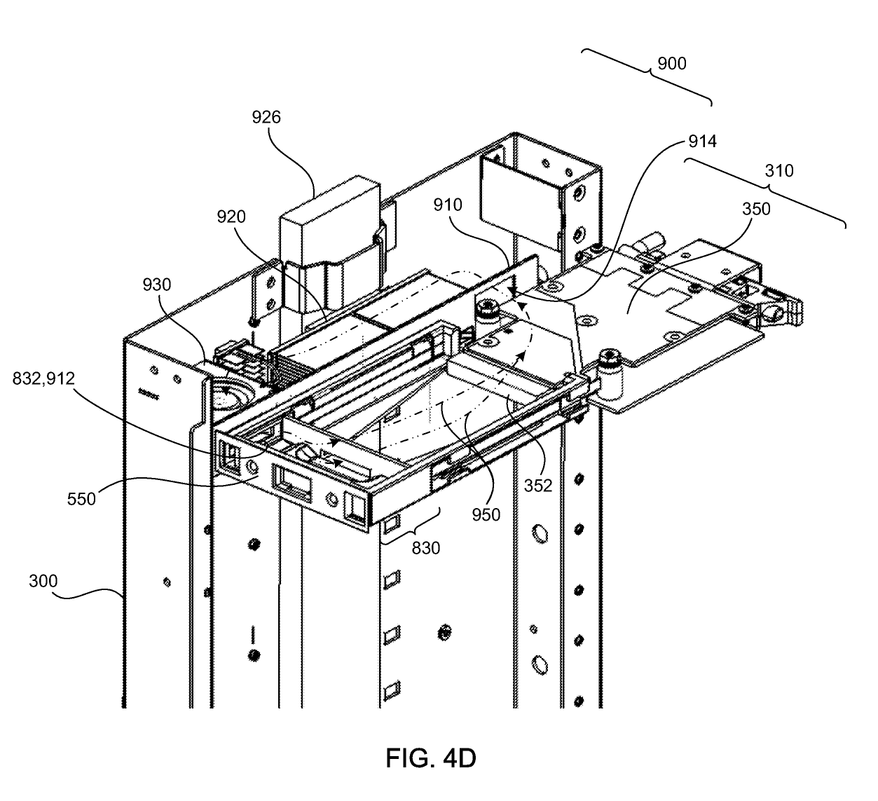

In implementations that employ storage device transporters 550 for manipulating storage devices 500, as shown in FIG. 4A, the robotic arm 200 is configured to remove a storage device transporter 550 from one of the test slots 310 with the manipulator 210, then pick up a storage device 500 from one the totes 700 presented at the transfer station 600 or other presentation system (e.g., conveyor, loading/unloading station, etc.) with the storage device transporter 550, and then return the storage device transporter 550, with a storage device 500 therein, to the test slot 310 for testing of the storage device 500. After testing, the robotic arm 200 retrieves the tested storage device 500 from the test slot 310, by removing the storage device transporter 550 carrying the tested storage device 500 from the test slot 310 (i.e., with the manipulator 210), carrying the tested storage device 500 in the storage device transporter 550 to the transfer station 600, and manipulating the storage device transporter 550 to return the tested storage device 500 to one of the totes 700 at the transfer station 600 or other system (e.g., conveyor, loading/unloading station, etc.).

In the examples illustrated in FIGS. 4A-4D, each test slot 310 is configured to receive the storage device transporter 550. The storage device transporter 550 is configured to receive the storage device 500 and be handled by the manipulator 210 of the robotic arm 200. In use, one of the storage device transporters 550 is removed from or delivered to one of the test slots 310 by the robotic arm 200.

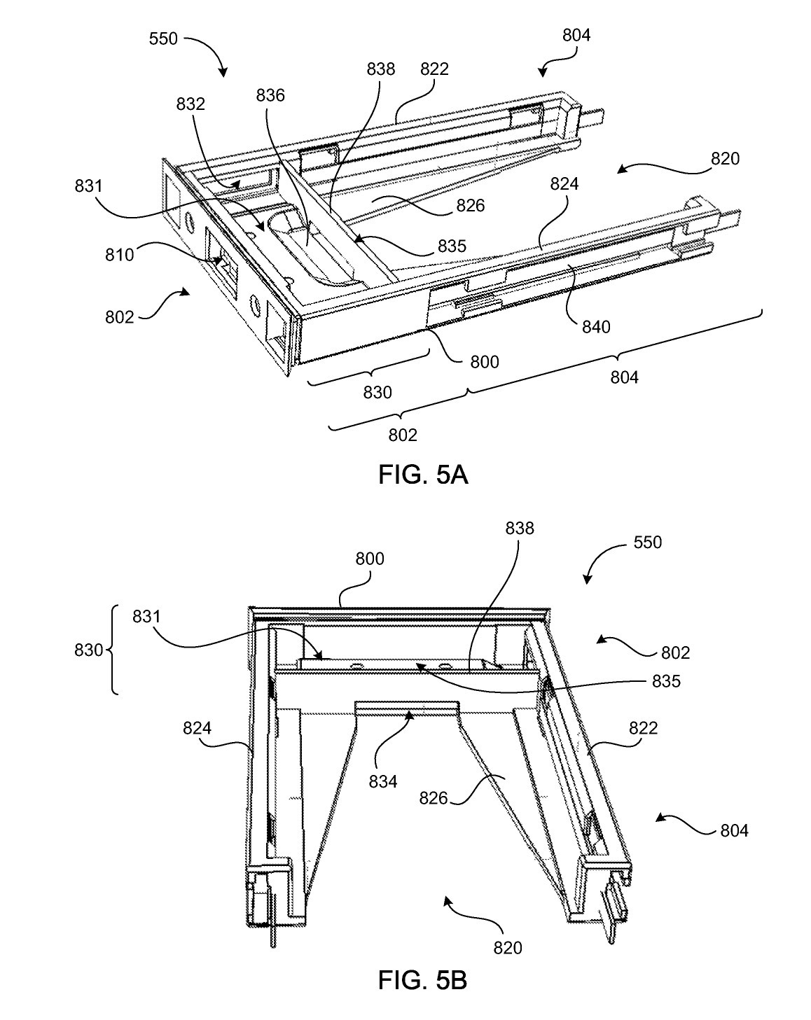

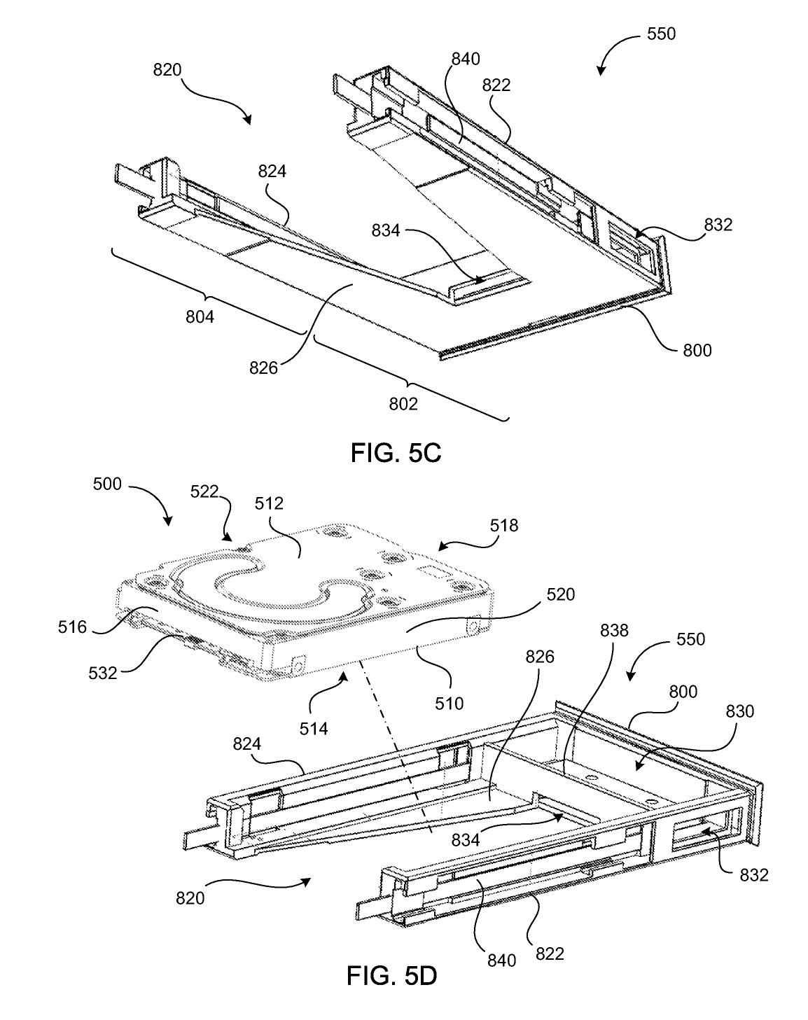

As illustrated in FIGS. 5A-5D, the storage device transporter 550 includes a transporter body 800 having first and second portions 802, 804. The first portion 802 of the transporter body 800 includes a manipulation feature 810 (e.g., indention, protrusion, etc.) configured to receive or otherwise be engaged by the manipulator 210 for transporting. The second portion 804 of the transporter body 800 is configured to receive a storage device 500. In some examples, the second transporter body portion 804 defines a substantially U-shaped opening 820 formed by first and second sidewalls 822, 824 and a base plate 826 of the transporter body 800. The storage device 500 is received in the U-shaped opening 820 and supported by at least the base plate 826. FIG. 5D illustrates an exemplary storage device 500 that includes a housing 510 having top, bottom, front, rear, left and right surfaces 512, 514, 516, 518, 520, 522. The storage device 500 is typically received with its rear surface 518 substantially facing the first portion 802 of the storage device transporter body 800. The first portion 802 of the transporter body 800 includes an air director 830 that receives and directs air substantially simultaneously (e.g., in parallel) over at least the top and bottom surfaces 512, 514 of the storage device 500 received in the storage device transporter 550.

With the storage device 500 received within the transporter body 800, the storage device transporter 550 and the storage device 500 together can be moved by the automated transporter 200 for placement within one of the test slots 310.

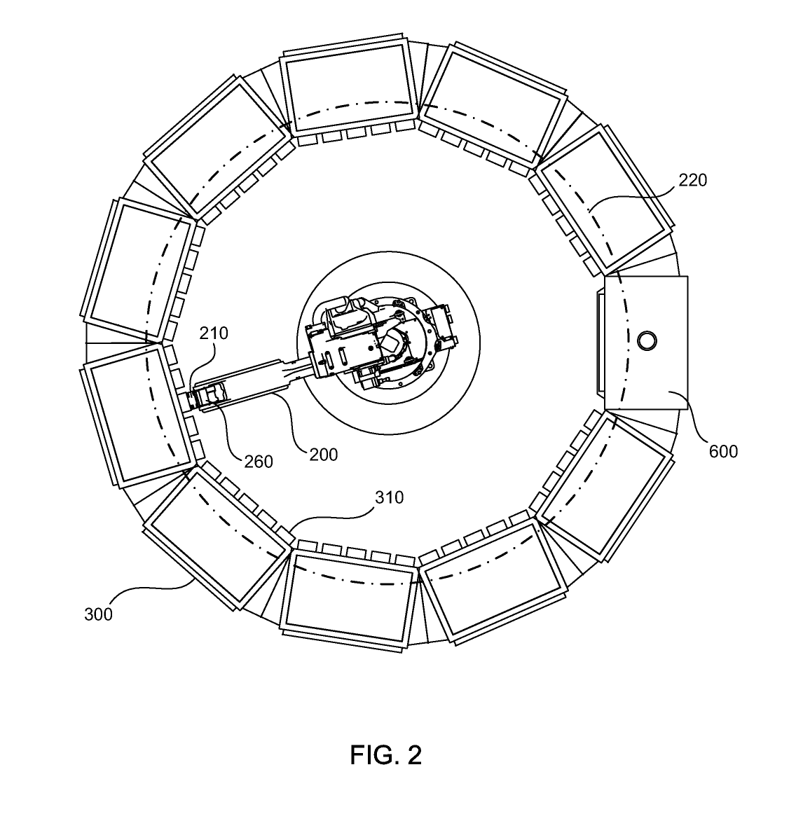

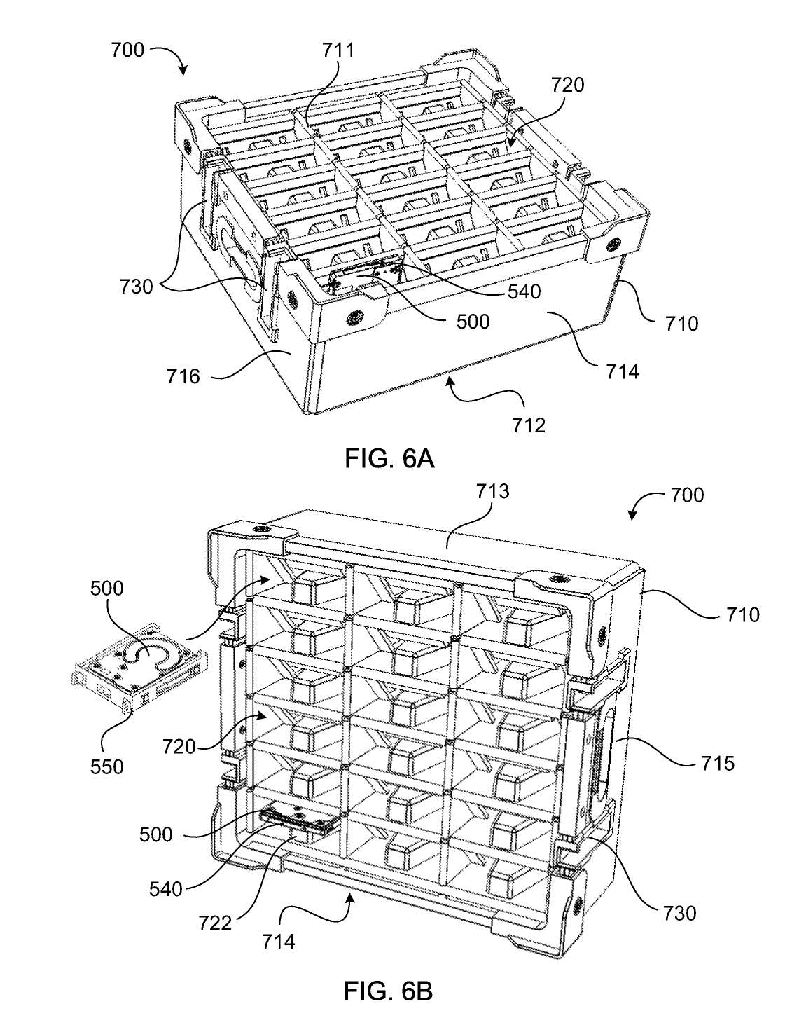

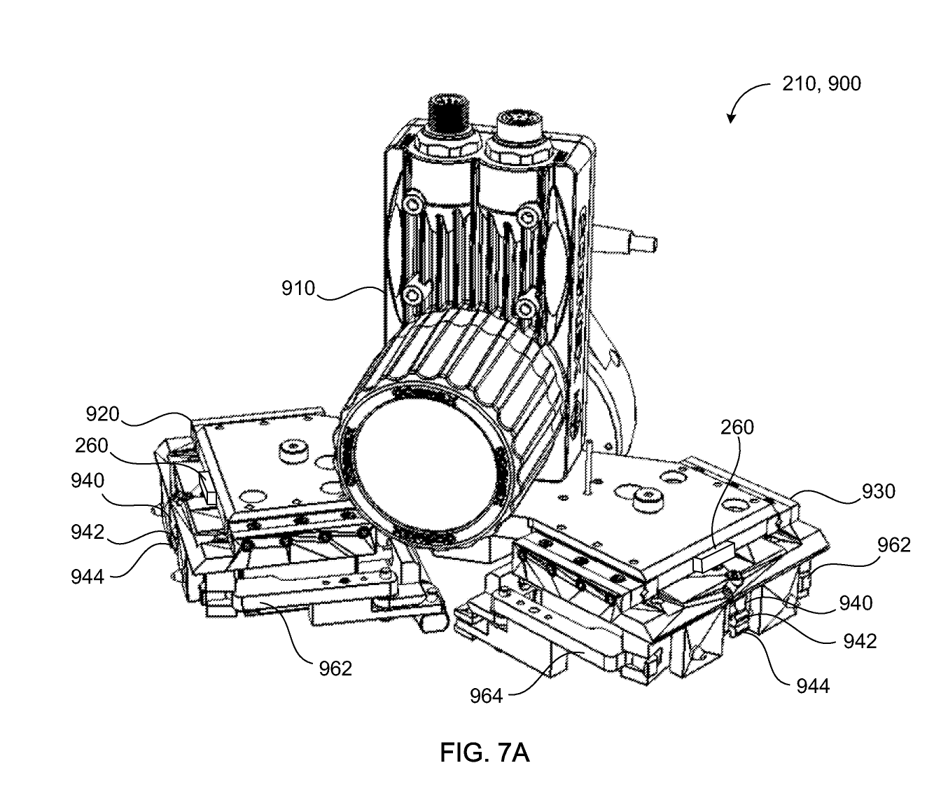

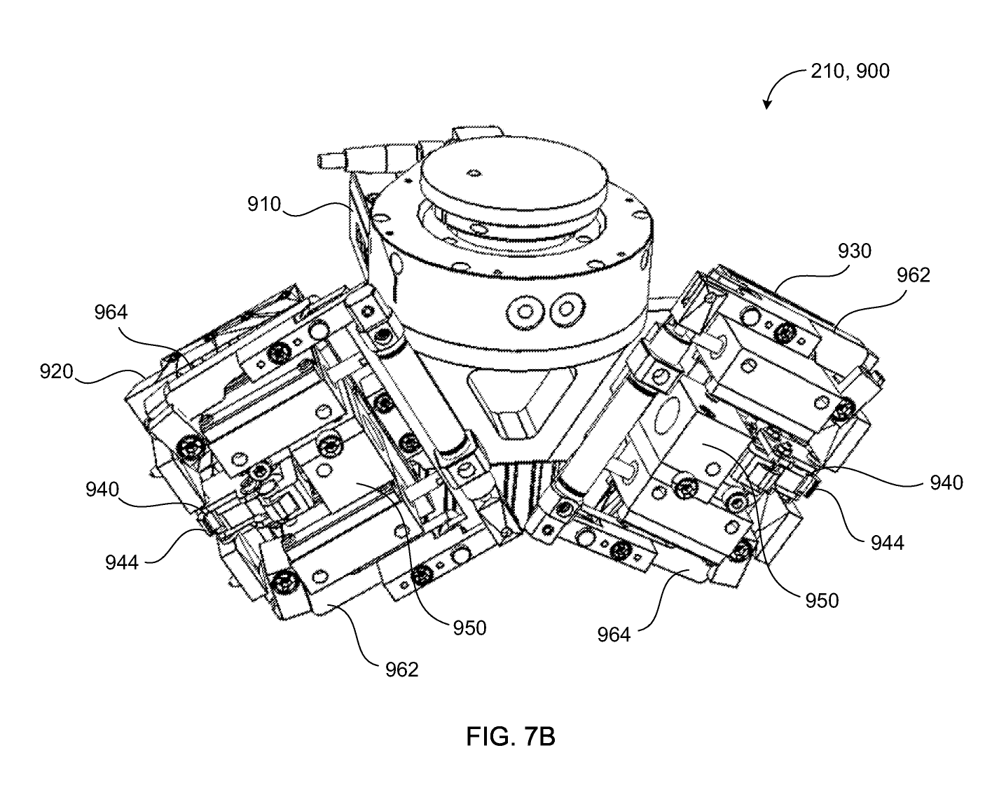

Referring to FIGS. 6A and 6B, when a collection of storage devices 500 are presented for testing, for example in a tote 700, the robotic arm 200 is actuated to scan or read a label or indicia 540 (e.g. bar code, symbol, picture, or other general or unique identifier) on each storage device 500 with a scanner, camera, or optical device 260 (see FIGS. 2 and 7A) disposed on the robotic arm 200 (preferably on the manipulator 210) before retrieving them and delivering them to test slots 310. For example, when a source tote 700 is presented (or loaded onto the transfer station 600) for supplying a collection of storage devices 500 for testing, the robotic arm 200 is actuated to scan the label 540 on each storage device 500 presented in the tote 700. The label 540 may contain information specific to the storage device 500 (e.g. capacity, type, preferred functionality test, manufacturer, etc.) or other information such as a batch or routing information, or a serial number that may be used to obtain information specific to the storage device 500 from a computer database. The controller 400 receives the scanned information on the labels 540 from the scanner 260 and may use this information, along with information provided by the test slots 310, to determine an optimized path of travel for the robotic arm 200 for servicing the test slots 310 and/or storage devices 500. This travel path optimization will be described in further detail below.

In some implementations, the tote 700 includes a tote body 710 having a front side 711, a back side 712, a top side 713, a bottom side 714, a right side 715 and a left side 716. The tote body 710 defines multiple storage device receptacles 720 in the front side 711 that are each configured to house a storage device 500. In some examples, the tote 700 rests on its back side 712 while in the loading position, such that the storage device receptacles 720 are substantially vertical and face upward, as shown in FIG. 6A. In other examples, the tote 700 is held in another orientation while in the loading position, such as at an incline or in a vertical orientation, as with the presentation position. In the presentation position, the tote 700 is presented such that the storage device receptacles 720 are substantially horizontal and face laterally, as shown in FIG. 6B. The tote body 710 defines arm grooves 730 in the right and left sides 715, 716 of the tote body 710 that are configured to support the tote 700.

In the example shown, each storage device receptacle 720 includes a storage device support 722 configured to support a central portion of the received storage device 500 to allow manipulation of the storage device 500 along non-central portions. To remove a housed storage device 500 from the storage device receptacle 720, the storage device transporter 550 is positioned below the storage device 500 (e.g. by the robotic arm 200) in the storage device receptacle 720 and elevated to lift the storage device 500 off of the storage device support 722. The storage device transporter 550 is then removed from the storage device receptacle 720 while carrying the storage device 500 for delivery to a destination target, such as a test slot 310.

Referring to FIGS. 7A and 7B, in some implementations, the manipulator 210, 900 includes first and second arms 920, 930 disposed on a manipulator body 910. The first and second arms 920, 930 can be arranged at an acute angle with respect to each other (e.g., in a substantially V-shaped configuration as shown), or in other arrangements, such as 180 degrees or some other angle from each other, substantially parallel to each other, and/or spaced from each other along one or more axes of directions (e.g., spaced along x, y, or z orthogonal directions). The arms 920, 930 each have connectors 940 configured to releasably attach to a storage device transporter 550. In the examples shown, each connector 940 includes first and second tabs 942, 944 opposedly coupled to a tab actuator 950 disposed on the arm 920,930. The tab actuator 950 is operable to move its coupled tabs 942, 944 in opposing directions to releasably engage and hold a storage device transporter 550. To grab the storage device transporter 550, the robotic arm 200 and manipulator 900 are actuated to maneuver one of the connectors 940 to place the tabs 942, 944 into the manipulation feature 810 of the storage device transporter 550 and then actuate the tab actuator 940 to move the tabs 942, 944 away from each other and engage the manipulation feature 810 to releasable attach to the storage device transporter 550. In some examples, the tabs 942, 944 are hook shaped and/or have friction pads to engage the manipulation feature 810 of the storage device transporter 550. Other manipulators 210, details and features combinable with those described herein may be found in U.S. patent application Ser. No. 12/424,980, filed on Apr. 16, 2009, which is hereby incorporated herein by reference in its entirety.

A method of performing storage device testing includes presenting one or more storage devices 500 to a storage device testing system 100 for testing at a source location (e.g., a loading/unloading station 600, storage device tote 700, test slot(s) 310, etc.) and actuating an automated transporter 200 (e.g. robotic arm) to retrieve one or more storage devices 500 from the source location and deliver the retrieved storage device(s) 500 to corresponding test slots 310 disposed on a rack 300 of the storage device testing system 100. The method includes actuating the automated transporter 200 to insert each retrieved storage device 500 in its respective test slot 310, and performing a test (e.g., functionality, power, connectivity, etc.) on the storage devices 500 received by the test slot 310. The method may also include actuating the automated transporter 200 to retrieve the tested storage device(s) 500 from the test slot(s) 310 and deliver the tested storage device(s) 500 to a destination location (e.g., another test slot 310, a storage device tote 700, a loading/unloading station 600, etc).

In some implementations, the method includes shuffling storage devices 500 amongst test slots 310 by actuating the robotic arm 200 to remove a first storage device 500 from a first test slot 310 and carrying it with the first arm 920 of the manipulator 900, moving to a second test slot 310 and removing a second storage device 500 and carrying it with the second arm 930 of the manipulator 900, and then inserting the first storage device 500 into the second slot 310. The method may also include actuating the robotic arm 200 to move the second storage device to the first test slot 310 and inserting the second storage device 500 in the first test slot 310. For this mode of operation (storage device shuffling), the dual-armed manipulator 900 provides distinct advantages over a single-armed manipulator by allowing direct exchanges of storage devices 500 at each stop, rather than having to take a storage device 500 out of a first test slot 310, park the storage device 500 in an empty slot 310 or in a tote 700, retrieve another storage device 500 from a second slot 310 and insert that storage device 500 into the first test slot 310, and then retrieve the parked storage device 500 and insert it in the second slot 310. The dual-armed manipulator 900 removes the step of parking one of the storage devices 500 while swapping storage devices 500 amongst two test slots 310.

In retrieving one or more of the presented storage devices 500 for testing, the method preferably includes actuating the robotic arm 200 to retrieve a storage device transporter 550 (e.g. from a test slot 310 housed in a rack 300), and actuating the robotic arm 200 to retrieve one of the storage devices 500 from the transfer station 600 and carry the storage device 500 in the storage device transporter 550. The method includes actuating the robotic arm 200 to deliver the storage device transporter 550 carrying the storage device 500 to the test slot 310 for performing a functionality test on the storage device 500 housed by the received storage device transporter 550 and the test slot 310. In some examples, delivering the storage device transporter 550 to the test slot 310 includes inserting the storage device transporter 550 carrying the storage device 500 into the test slot 310 in the rack 300, establishing an electric connection between the storage device 500 and the rack 300. After testing is completed on the storage device 500, the method includes actuating the robotic arm 200 to retrieve the storage device transporter 550 carrying the tested storage device 500 from the test slot 310 and delivering the tested storage device 500 back to a destination location, such as a destination storage device tote 700 on the transfer station 600. In some implementations, the rack 300 and two or more associated test slots 310 are configured to move storage devices 500 internally from one test slot 310 to another test slot 310, in case the test slots 310 are provisioned for different kinds of tests.

In some implementations, the robotic arm 200 includes the manipulator 900, discussed above, which allows the robotic arm 200 to retrieve, handle, and deliver multiple storage devices 500 and/or storage device transporters 550. For example, the robotic arm 200 can retrieve and carry one untested storage device 500 in a storage device transporter 500 held by one arm 920, 930 of the manipulator 900, and deliver the untested storage device 500 to a test slot 310. At the test slot 310, the robotic arm 200 removes a storage device transporter 550 carrying a test storage device 500 currently in the test slot 310, before inserting the storage device transporter 550 carrying the untested storage device 500 into the test slot 310 for testing. The robotic arm 200 then delivers the tested storage device 500 to a destination location, such as a receptacle 720 of a destination storage device tote 700. In another example, the robotic arm 200 can retrieve and carry two untested storage devices 500, one on each arm 920, 930 of the manipulator 900, and then deliver the two untested storage devices 500 to respective test slots 310 for testing. The robotic arm 900 can then be actuated to retrieve two tested storage devices 500 from their respective slots 310 (e.g. by engaging and removing their respective storage device transporters 550 with the manipulator 900), and deliver the tested storage devices 500 to a destination location, such as two receptacles 720 of one or more destination storage device totes 700. If one tested storage device 500 passed the storage device testing and the other failed, they may be placed in different destination storage device totes 700, such a “passed” storage device tote 700 and a “failed” storage device tote 700.

The manipulator 900 allows the robotic arm 200 to move multiple storage devices 500 and/or storage device transporters 550 within the storage device testing system 100 to accomplish more tasks than previously achievable by a manipulator capable of only handling one storage device 500 and/or storage device transporter 550 at a time. The increased flexibility allows for path planning of the robotic arm 200 to optimize its movements. Routines 1000 for optimizing the movements of the robotic arm 200 can be stored on and/or communicate to the controller 400 and executed by the controller 400 to optimize movements of the robotic arm 200 between storage device sources and destinations, such as test slots 310 and/or storage device tote receptacles 720. For example, between test slots 310 (e.g. for storage device swapping), between a test slot and a storage device tote receptacle 720, between storage device tote receptacles 720 (e.g., between source and destination totes 700), and combinations thereof.

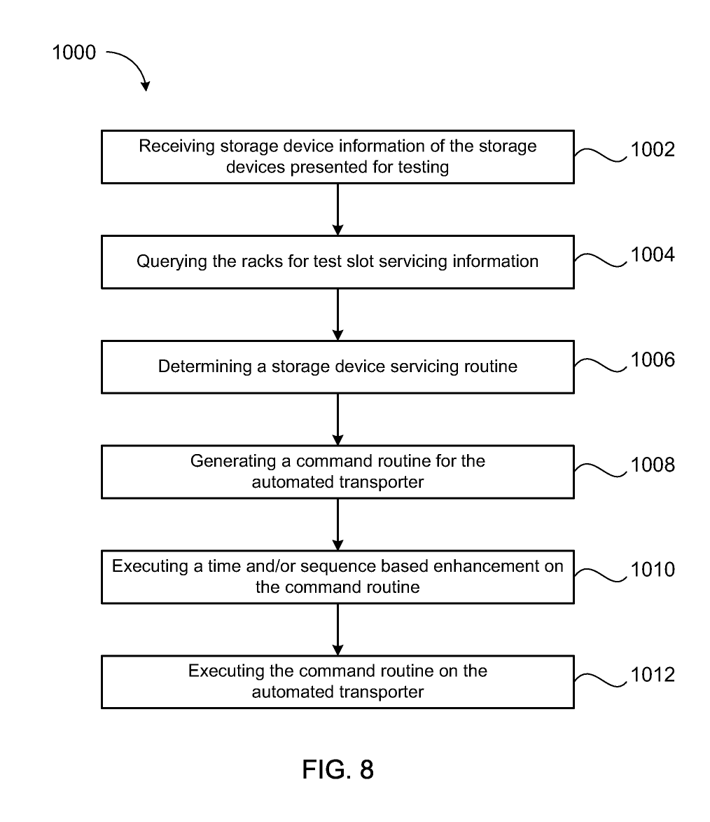

FIG. 8 provides a flow chart 1000 of an exemplary arrangement of operations for transferring storage devices 500 within the storage device testing system 10. These operations may be stored on or communicated to the controller 400, which may execute the operations. Operations for transferring storage devices 500 from a source location (e.g., one or more source totes 700, test slots 310, or staging slots 311) to a destination location e.g., one or more source totes 700 or test slots 310, or staging slots 311) includes receiving 1002 storage device information of the storage devices 500 presented for testing (e.g., by scanning the presented storage devices 500), and querying 1004 the racks 300 to obtain test slot servicing information, such as a lists of available/uncommitted test slots 310 and/or test slots 310 that need servicing (e.g., test slots that have finished testing a received storage device 500). In some cases, the information may be received from the transfer station or a test slot (e.g., because a test has finished). In practice, there can be a constant stream of incoming information. Operations include determining 1006 a storage device servicing routine based on the storage device information and the test slot servicing information. The servicing routine includes storage device transfers for transferring storage devices 500 between first and second locations. This may include determining which storage devices 500 will be serviced (e.g., which storage devices 500 will be delivered to or retrieved from test slots 310 and/or tote receptacles 720). Operations also include producing 1008 a command routine for executing the servicing routine. The command routine includes a sequence of automation moves for execution by an automated transporter 200 (e.g., robotic arm) configured to handle one or more storage devices 500 during a single automation move. This may entail determining a delivery order and path of movement for the automated transporter 200 when transferring storage devices 500 between the first and second locations (e.g., feeding a collection of untested storage devices 500 to the storage device system 100). Operations also executing 1010 a time-based and/or sequence-based enhancement on the command routine, and executing 1012 the command routine on the automated transporter 200. Requests to move a storage device is added to a queue of such requests, and the optimization is performed on the first few entries in the queue. The time-based enhancement includes selecting a second automation move based on a start location of the second automation move and an end location of a sequentially preceding first automation move. The sequence-based enhancement includes producing a reduced sequence of automation moves for one or more storage device transfers (e.g., relative to a non-enhanced or non-optimized command routine).

The enhanced/optimized command routine includes a list of sequential commands or automation moves to move the robotic arm 200 between a source location (e.g., a tote 700 at the transfer station 600) and a destination location (e.g., the test slots 310) in an efficient manner. The command routine coordinates extraction of tested storage devices 500 and their delivery to one or more destination locations (e.g. destination totes 700). For example, if five untested storage devices 500 are presented for testing, the robotic am 200 will scan the respective labels 540 of the five storage devices 500 with the scanner 2620 to obtain the label information. The controller 400 receives the label information and uses the label information, or information from a database based on the label information, along with status or state information of the test slots 310 to determine which storage devices 500 will be delivered to which test slots 310. The assignment of storage devices 500 to certain test slots 310 may depend on the type of storage device testing that needs to be done on each storage device 500 and which test slot 310 is provisioned for that type of testing and which test slot 310 is available and configured for that type of storage device 500 and/or type of required testing. The controller 400 produces a list of storage device transfers (servicing routine) for execution on the robotic arm 200 to deliver storage devices 500 to their assigned destination. The controller 400 produces a command routine that includes a sequential list of commands for automation moves to effectuate the storage device transfers. The optimization or enhancement routine modifies the command routine to minimize the time required to complete the overall task. This entails determining an order of delivery of each untested storage devices 500 to each assigned test slot 310 as well as an order of retrieval of tested storage devices and their delivery to destination locations (e.g., tote receptacles 720). In storage device systems 100 having a dual-armed manipulator 900, as shown in FIGS. 7A and 7B, the command list may contain commands for storage device swapping amongst test slots 310 and/or for delivering an untested storage device 500 on an outbound trip from a transfer station 600 and returning a tested storage device 500 from the serviced test slot 310 on an inbound trip to the transfer station 600 (e.g. without having to park one of the storage devices 500 in a staging slot 311 for executing the swap).

To increase efficiency and optimize movement of the robotic arm 200, the controller 400 may execute an optimization/enhancement routine (which may be stored in memory thereon or communicated thereto) that selects and directs automation moves (e.g., robotic arm movements) based on movement-time and/or movement-sequence. An automation move based on movement-time is selected by assessing a number of possible storage device transfers (e.g., moving one or more storage devices 500 between test slots 310, from a test slot 310 to a tote 700, etc.), calculating the amount of time required for the robotic arm 200 to execute the transfer of a storage device 500 between a source location and a destination location, and selecting the storage device transfer with the lowest projected execution time. An automation move based on movement-sequence may include combining multiple automation moves while modifying or eliminating one or more automation moves to execute all of the storage device transfers. The controller 400 may execute both movement-time and movement-sequence enhancement routines on a command routine.

In some implementations, executing the time-based enhancement on the command routine includes selecting a second automation move based a travel time of the automated transporter between the start location of the second automation move and the end location of a preceding first automation move. Executing the time-based enhancement on the command routine may include arranging a set of one or more automation moves of a first storage device transfer to be sequentially adjacent a set of one or more automation moves of a second storage device transfer. In some examples, the first storage device transfer comprises moving a first storage device 500 between a first test slot 310 and a first presentation location (e.g., one of the tote receptacles 720), and the second storage device transfer comprises moving a second storage device 500 between a second presentation location (e.g., one of tote receptacles 720) and a second test slot 310. The first and second test slots 310 may be the same test slot 310. The first and second presentation locations can be the same presentation location (e.g., the same tote receptacle 720). In other examples, the first storage device transfer comprises moving a first storage device 500 between a first test slot 310 and a second test slot 310, and the second storage device transfer comprises moving a second storage device 500 between the second test slot 310 and a presentation location.

In some implementations, executing the sequence-based enhancement on the command routine includes producing a fixed sequence of automation moves for a combination of two or more storage device transfers. Executing the sequence-based enhancement on the command routine may include producing a combined automation move that replaces a sequentially first automation move and a sequentially second automation move. In some examples, the sequentially first automation move comprises depositing an empty first storage device transporter 550 and the sequentially second automation move comprises retrieving an empty second storage device transporter 550 for retrieving a storage device 500. The combined automation move includes using the first storage device transporter 550 to retrieve the storage device 500.

For a storage device testing system 100 having racks 300 arranged in a substantially circular layout about a single robotic arm 200, as shown in FIGS. 1 and 2, the robotic arm movements can be optimized for certain types of moves. In some implementations, the controller 400 may select an automation move (e.g., a movement of the robotic arm 200) based on one or more previous automation moves. For example, the starting location for a second move should be chosen closest to the ending location of a first move. However, this may not always be possible in all cases without modifying the way test slots 310 are allocated. A prioritization of automation move types may take precedence over storage device delivery enhancements or optimizations. Table 1 below provides an exemplary representation of when the controller 400 may enhance the automation moves (also referred to a move types or moves) between first and second automation moves.

TABLE 1

| | | Second Move | | | | |
|---|---|---|---|---|---|---|
| | | T2T | R2R | Combo | R2T | T2R |
| First Move | T2T | Sequence | Sequence | Sequence | Sequence | No Optimize |
| | | Optimize | Optimize | Optimize | Optimize | |
| | R2R | No Optimize | Optimize | Optimize | Optimize | No Optimize |
| | Combo | Time | Optimize | Optimize | Optimize | No Optimize |
| | | Optimize | | | | |
| | R2T | Sequence | Optimize | Optimize | Optimize | No Optimize |
| | | Optimize | | | | |
| | T2R | Time | Optimize | Optimize | Optimize | No Optimize |
| | | Optimize | | | | |

Automation moves include tote-to-tote (T2T), rack-to-rack (R2R), rack-to-tote (R2T), tote-to-rack (T2R), and a combination thereof (Combo). A tote-to-tote (T2T) move includes moving a storage device 500 from a first tote receptacle 720 to a second tote receptacle 720 of a tote 700 or from a tote receptacle 720 of a first tote 700 to a tote receptacle 720 of a second tote 700. A rack-to-rack (R2R) move includes moving a storage device 500 from a first test slot 310 to another test slot 310 within the same rack 300 or between two racks 300. The rack-to-tote (R2T) move includes moving a storage device 500 from a test slot 310 of a rack 300 to a tote receptacle 720 of a tote 700. A tote-to-rack (T2R) move includes moving a storage device 500 from a tote receptacle 720 of a tote 700 to a test slot 310 of a rack 300. A Combo move can be executed when a first storage device 500 is waiting to move from any tote receptacle 720 to a specific test slot 310, and a second storage device 500 is waiting to move from that same test slot 310 to any tote receptacle 720.

When the first automation move is a Combo or T2R and the second automation move is a T2T, a movement-time or time-based enhancement may be executed. The first action in a T2T move is to retrieve a storage device transporter 550 from a staging slot 311 of the rack 300 (e.g., a staging or designated slot or collection of slots for holding or staging a storage device transporter 550). The controller 400 may choose a first move that it is close to the staging slots 311.

A determination of closeness between automation moves may depend on a number of factors. Moves across the same row of test slots 310 in a rack 300 may be quicker than moves along the same column of test slots 310 in a rack 300. In some examples, there may be a penalty considered in the determination for automation moves that traverse the transfer station 600. A penalty may also be assessed for automation moves that require the robotic arm 200 to move near its full range of motion (e.g., a nearly 360-degree pirouette).

For the exemplary storage device testing system 100 shown in FIGS. 1 and 2, the controller 400 will “renumber” the racks and columns as shown in Table 2 below. The transfer station 600 will be considered to be Rack #0.

TABLE 2
Feeder

| | | | | | | | | | | | |
|---|---|---|---|---|---|---|---|---|---|---|---|
| 6 | 7 | 8 | 9 | 10 | 0 | 1 | 2 | 3 | 4 | 5 | Rack Index |
| 0 | 1 | 2 | 3 | 4 | 5 | 6 | 7 | 8 | 9 | 10 | Adj Rack Index |

| | | | | | | | | | |
|---|---|---|---|---|---|---|---|---|---|
| 0 1 2 3 4 5 6 7 8 9 10 | 15 | 20 | 25 | 30 | 35 | 40 | 45 | 50 54 | Adj. Column Index |

The Adjusted Column Index can be determined from the column and rack indices as follows:

I_{A}=5*(10−Mod(16−I_{K},11))+I_{C}−1 (1)

where:

I_{A} is the Adjusted Column Index;

I_{R} is the Rack Index (e.g., 1 through 10, or 0 for the feeder); and

I_{C} is the Column Index (e.g., 1 through 5).

The time T required for the robot to move from one location to another is:

$$T = \frac{Δ {I}_{A} * {D}_{C}}{{V}_{H}} + \frac{Δ {I}_{R} * {D}_{R}}{{V}_{V}} \qquad ( 2 )$$

where:

V_{V} is the vertical robot velocity (velocity along a constant column of test slots 310);

V_{H} is the horizontal velocity (velocity across a constant row of test slots 310);

ΔI_{A} is the number of adjusted columns between the start and end of the move;

D_{C} is the distance between test slot columns;

ΔI_{R} is the number of rows between the start and end of the move; and

D_{R} is the distance between rows.

The above calculation ignores the following factors: rows of test slots 310 are clustered in groups of 12; adjacent columns of test slots 310 within a rack 300 may not be the same distance apart as adjacent columns of test slots 310 between different racks 300; and the robotic arm 200 has to accelerate and decelerate for each move. The above expression also depends on the robotic arm 200 performing horizontal and vertical moves sequentially, rather than simultaneously.

The time T required for the robotic arm 200 to move from one location to another can also be expressed as:

T=ΔI_{A}*X+ΔI_{R} (3)

where X is an adjustable parameter. A default value of X can be determined empirically, and a user may have the option of changing it through a controller configuration (e.g., a Custom Defaults xml file).

If the robot instead moves as an XY-Table, where the X- and Y-motions are done simultaneously, and independently, the controller 400 may instead use the maximum of the X- and Y-times rather than the sum. The time T required for the robotic arm 200 to move from one location to another can be expressed as:

T=Max(ΔI_{A}*X,ΔI_{R}) (4)

A third option entails the robotic arm 200 moving directly from one location to the other, with a more-or-less constant speed. In this case, the time T required for the robotic arm 200 to move from one location to another can be expressed as:

$$T = \frac{\sqrt{{( Δ {I}_{A} * {D}_{C} )}^{2} + {( Δ {I}_{R} * {D}_{R} )}^{2}}}{V} \qquad ( 5 )$$

This can be simplified by removing the overall scaling factor and expressed as:

T=(ΔI_{A}*X)²+(ΔI_{R})² (6)

where X is some scaling factor reflecting the horizontal and vertical speeds.

Referring again to Table 1, when the first move is an R2T move and the second move is a T2T move, a movement-sequence or sequence-based enhancement may be executed. The robotic arm 200 will not return the storage device transporter 550 after the first move (e.g., to a tote 700 or a staging slot 311), and instead will use the storage device transporter 550 to perform the T2T move.

When the first automation move is a T2T move and the second automation move is an R2R, Combo, or R2T move, a movement-sequence or sequence-based enhancement may be executed. Furthermore, these sequences can be enhanced or optimized under movement-time (e.g., time-based enhancement) if the test slot 310 from the second automation move is chosen to be close to the staging slots 311, where “closeness” is a function of time calculated by the controller, a threshold travel time, and/or a threshold travel distance.

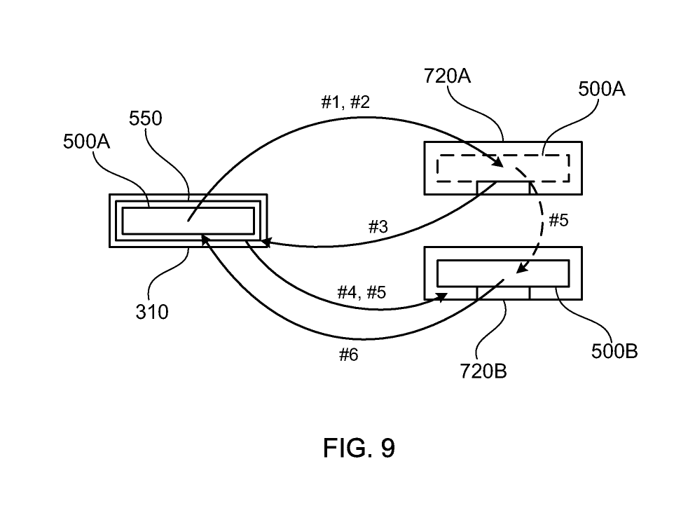

For an R2T-T2R Combo move, Table 3 provides a command routine having a sequence of automation moves that can be executed without implementing a sequence-based enhancement. FIG. 9 illustrates the non-enhanced and enhanced sequence of movements.

TABLE 3

| Sequence of Robotic Arm Moves | Description |
|---|---|
| #1. Pick a storage device transporter 550 | This combination performs the R2T |
| carrying a first storage device 500A from a test | move for a first storage device 500A. |
| slot 310. | The first storage device 500A moves |
| #2. Place the first storage device 500A into a | from the first test slot 310 to the first |
| first tote receptacle 720A of a tote 700. | tote receptacle 720A. |
| #3. Place the empty storage device transporter | |
| 550 into the test slot 310 (returning the storage | |
| device transporter 550). | |
| #4. Pick the empty storage device transporter | This combination of moves performs |
| 550 from the test slot 310. | the T2R move for a second storage |
| #5. Pick a second storage device 500B from a | device 500B. The second storage |
| second tote receptacle 720B, carrying the | device 500B moves from a second tote |
| second storage device 500B with the storage | receptacle 720B to the test slot 310. |
| device transporter 550. | |
| #6. Place the storage device transporter 550 | |
| into the test slot 310 (returning the storage | |
| device transporter 550 with the second storage | |
| device 500B). | |

While executing the R2T move and the T2K move sequentially, steps 3 and 4 are unnecessary (i.e., placing the storage device transporter 550 into the test slot 310, and then immediately removing it again). Table 4 provides a sequence of automation moves produced by a sequence-based enhancement of the command routine.

TABLE 4

| Sequence of Robotic Arm Moves | Description |
|---|---|
| #1. Pick a storage device transporter 550 | This combination performs the R2T move for |
| carrying a first storage device 500A from | a first storage device 500A. The first storage |
| a test slot 310. | device 500A moves from the test slot 310 to |
| #2. Place the first storage device 500A | the first tote receptacle 720A. |
| into a first tote receptacle 720A of a tote | |
| 700. | |
| #5. Pick a second storage device 500B | This combination of moves performs the |
| from a second tote receptacle 720B, | T2R move for a second storage device 500B. |
| carrying the second storage device 500B | The second storage device 500B moves from |
| with the storage device transporter 550. | a second tote receptacle 720B to the test slot |
| #6. Place the storage device transporter | 310. |
| 550 into the test slot 310 (returning the | |
| storage device transporter 550 with the | |
| second storage device 500B). | |

The sequence-based enhancement of the command routine reduces the number of robot actions from six to four.

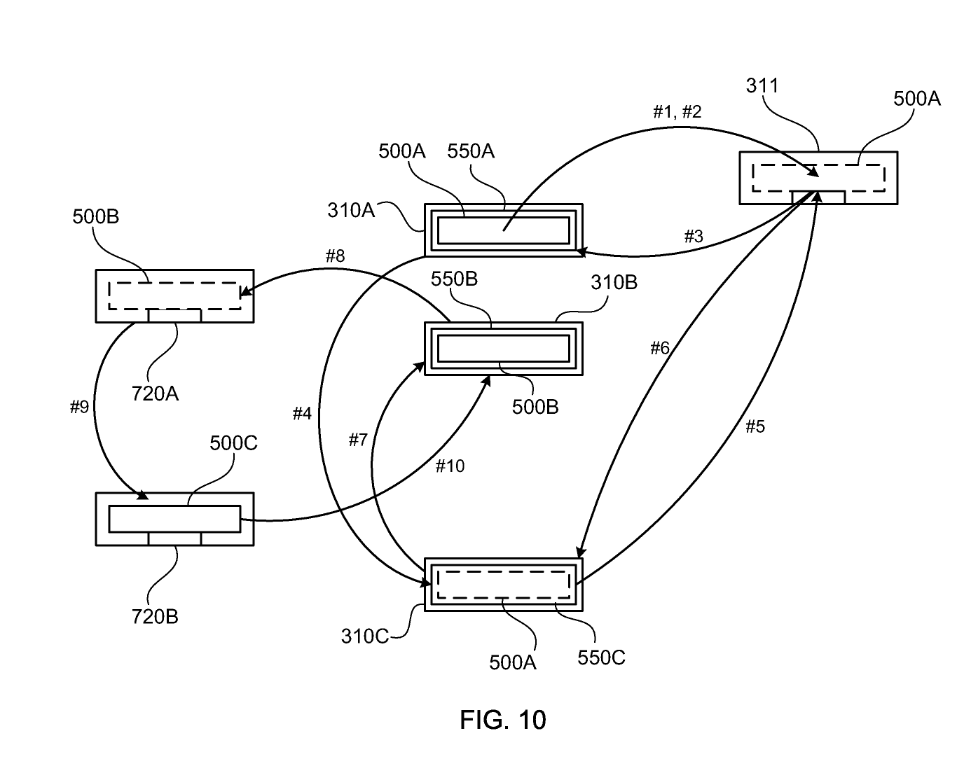

A sequence-based enhancement may be applied to an R2R move combined with the R2T-T2R Combo move. In this scenario, 1) a first storage device 500A is in a first test slot 310A, waiting for an R2R move, 2) a second storage device 500B is in a second test slot 310B waiting to be unloaded with an R2T move, and 3) a third storage device 500C is in a tote receptacle 720 waiting to be loaded with a T2R move (e.g., where moves 2 and 3 form a Combo move). Table 5 provides a command routine having a non-enhanced sequence of automation moves. FIG. 10 provides a schematic of the non-enhanced sequence of automation moves.

TABLE 5

| Sequence of Robotic Arm Moves | Description |
|---|---|
| #1. Pick a first storage device transporter 550A | This sequence of moves performs the |
| carrying a first storage device 500A from a | R2R move for the first storage device |
| first test slot 310A. | 500A. The first storage device 500A |
| #2. Place the first storage device 500A in a | moves from the first test slot 310A to |
| staging slot 311. | the third test slot 310C. |
| #3. Place the empty first storage device | |
| transporter 550A into the first test slot 310A | |
| (returning the storage device transporter 550). | |
| #4. Pick an empty third storage device | |
| transporter 550C from a third test slot 310C. | |
| #5. Pick the first storage device 500A from the | |
| staging slot 311. | |
| #6. Place the third storage device transporter | |
| 550C into the third test slot 310C (returning | |
| the storage device transporter 550 with the first | |
| storage device 500A). | |
| #7. Pick a second storage device transporter | This sequence of moves performs a |
| 550B carrying a second storage device 500B | Combo-move, unloading the second |
| from a second test slot 310B. | storage device 500B, and loading the |
| #8. Place the second storage device 500B into | third storage device 500C. |
| a first tote receptacle 720A of a tote 700 | |
| (unloading the second storage device 500B). | |
| #9. Pick a third storage device 500C from a | |
| second tote receptacle 720B of a tote 700 using | |
| the second storage device transporter 550B. | |
| #10. Place the second storage device | |
| transporter 550B carrying the third storage | |
| device 500C into the second test slot 310B | |
| (loading the third storage device 500C). | |

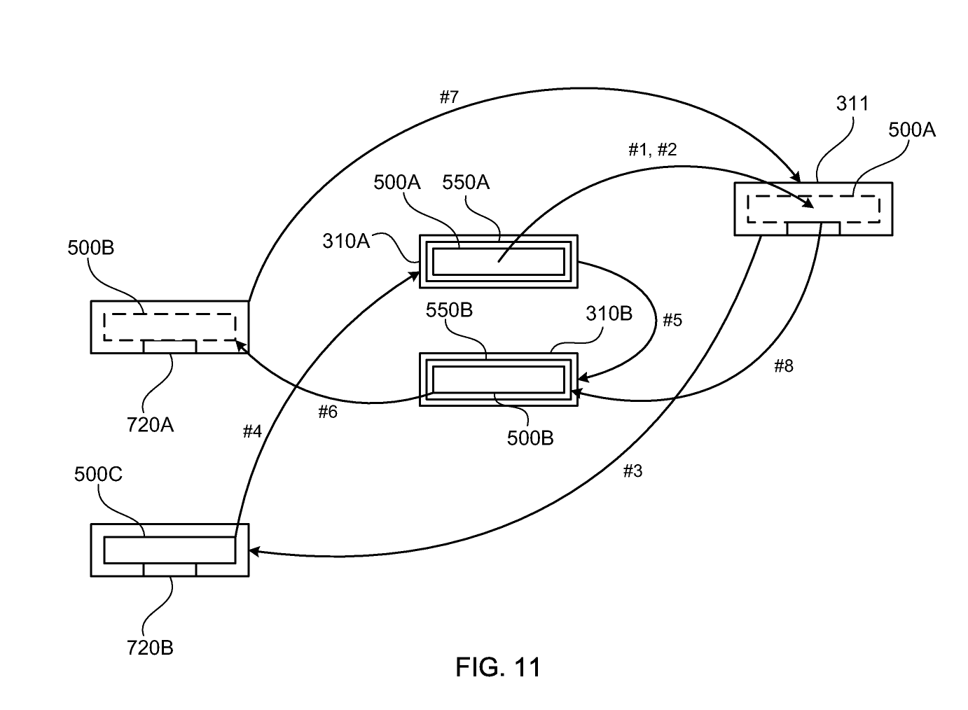

Table 6 provides a command routine having a sequence of automation moves produced by a sequence-based enhancement routine. FIG. 11 illustrates the sequence-based enhanced command routine.

TABLE 6

| Sequence of Robotic Arm Moves | Description |
|---|---|
| #1. Pick a first storage device transporter | |
| 550A carrying a first storage device 500A | |
| from a first test slot 310A. | |
| #2. Place the first storage device 500A in a | The first storage device |
| staging slot 311. | 500A is now in the |
| | fixed tier (e.g., a staging |
| | location). |
| #3. Pick a third storage device 500C from a | |
| second tote receptacle 720B of a tote 700 | |
| using the first storage device transporter | |
| 550A. | |
| #4. Place the first storage device | The third storage device |
| transporter 550A carrying the third storage | 500C is now loaded. |
| device 500C into the first test slot 310A | |
| (loading the third storage device 500C). | |
| #5. Pick a second storage device | |
| transporter 550B carrying a second storage | |
| device 500B from a second test slot 310B. | |
| #6. Place the second storage device 500B | The second storage device |
| into a first tote receptacle 720A of a tote | 500B is now unloaded. |
| 700 (unloading the second storage device | |
| 500B). | |
| #7. Pick the first storage device 500A from | |
| the staging slot 311 using the second | |
| storage device transporter 550B. | |
| #8. Place the second storage device | The first storage device |
| transporter 550B carrying the first storage | 500A is now loaded. |
| device 500A into the second test slot 310B | |
| (loading the third storage device 500A). | |

This sequence of automation moves requires only 8 operations, instead of 10, and has the benefit of not requiring an empty test slot 310C, which would be important if the testing system 100 was full.

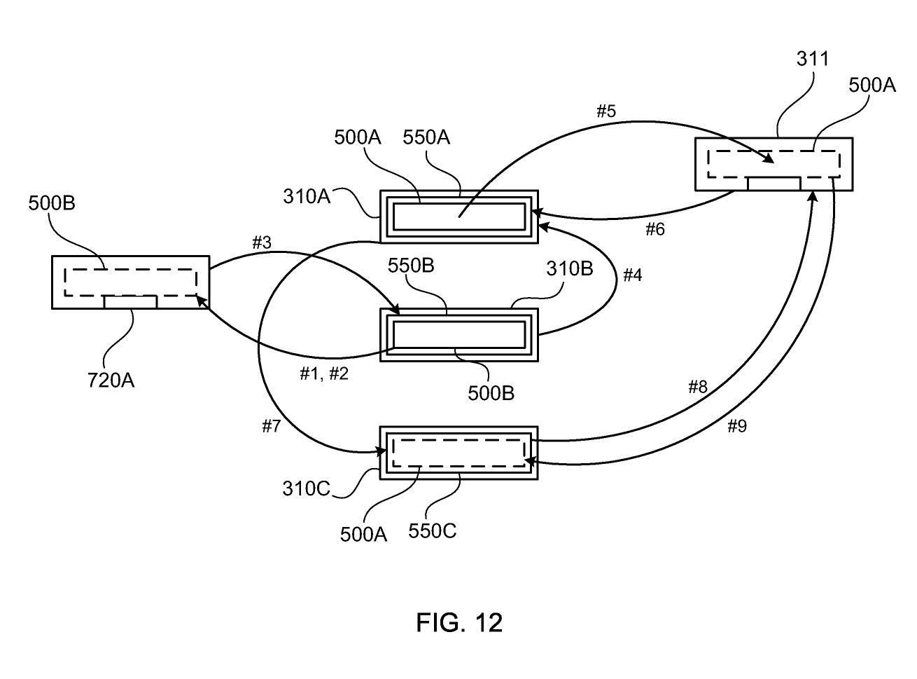

A sequence-based enhancement routine may be applied to combine an R2R move and an R2T move. In particular, an enhancement or optimization is possible if a rack-to-rack (R2R) move is scheduled, and an unload (R2T) is requested, and if the test slot 310 vacated by the unload is acceptable to the storage device 500 being moved from one rack 300 to another. In this scenario, 1) a first storage device 500A in a first test slot 310A is waiting for a rack-to-rack move, and 2) a second storage device 500B in a second test slot 310B waiting to be unloaded to the transfer station 600 (e.g., to a tote receptacle 720). Table 7 provides a command routine having a non-enhanced sequence of automation moves. FIG. 12 provides a schematic of the non-enhanced sequence of automation moves.

TABLE 7

| Sequence of Robotic Arm Moves | Description |
|---|---|
| #1. Pick a second storage device transporter | These steps move the second storage |
| 550B carrying a second storage device 500B | device 500B to a tote 700. |
| from a second test slot 310B. | |
| #2. Place the second storage device 500B into | |
| a tote receptacle 720 of a tote 700 (unloading | |
| the second storage device 500B). | |
| #3. Place the empty second storage device | |
| transporter 550B into the second test slot 310B | |
| (returning the storage device transporter 550). | |
| #4. Pick a first storage device transporter 550A | This combination of moves performs |
| carrying a first storage device 500A from a | the rack-to-rack move for the first |
| first test slot 310A. | storage device 500A. The first storage |
| #5. Place the first storage device 500A in a | device 500A moves from the first test |
| staging slot 311. | slot 310A A to the third test slot 310C. |
| #6. Place the empty first storage device | |
| transporter 550A into the first test slot 310A | |
| (returning the storage device transporter 550). | |
| #7. Pick an empty third storage device | |
| transporter 550C from a third test slot 310C. | |
| #8. Pick the first storage device 500A from the | |
| staging slot 311 using the third storage device | |
| transporter 550C. | |
| #9. Place the third storage device transporter | |
| 550C carrying the first storage device 500A | |
| into the third test slot 310C (loading the third | |
| storage device 500A). | |

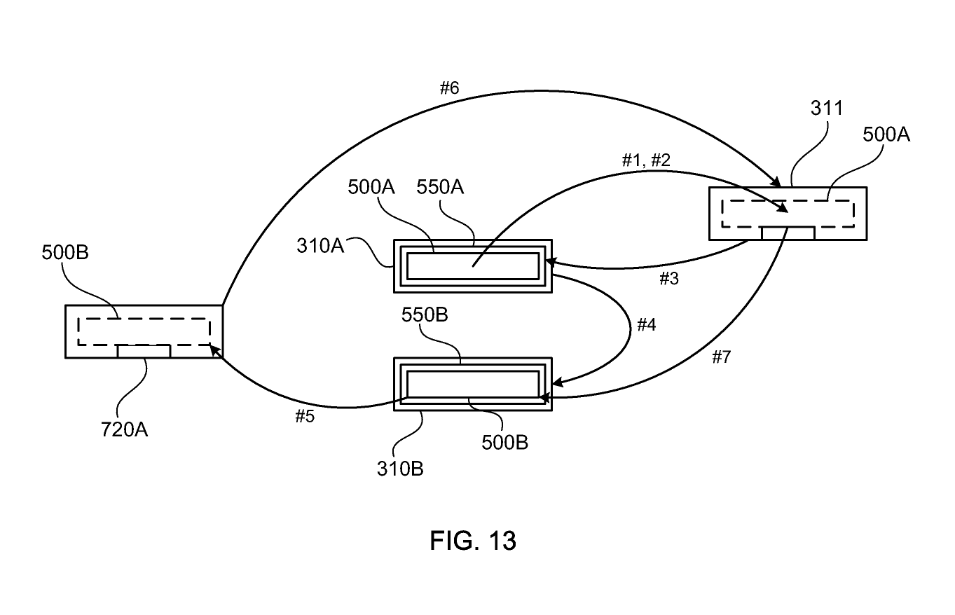

Table 8 a command routine having a sequence of automation moves produced by a sequence-based enhancement routine. FIG. 13 illustrates the sequence-based enhanced command routine.

TABLE 8

| Sequence of Robotic Arm Moves | Description |
|---|---|
| #1. Pick a first storage device transporter | |
| 550A carrying a first storage device 500A | |
| from a first test slot 310A. | |
| #2. Place the first storage device 500A in a | The first storage device |
| first staging slot 311. | 500A is now in the |
| | fixed tier. |
| #3. Place the empty first storage device | |
| transporter 550A into the first test slot | |
| 310A (returning the storage device | |
| transporter 550). | |
| #4. Pick a second storage device | |
| transporter 550B carrying a second storage | |
| device 500B from a second test slot 310B. | |
| #5. Place the second storage device 500B | The second storage device |
| into a tote receptacle 720 of a tote 700 | 500B is now unloaded |
| (unloading the second storage device | |
| 500B). | |
| #6. Pick the first storage device 500A from | |
| the staging slot 311 using the second | |
| storage device transporter 550B. | |
| #7. Place the second storage device | The first storage device |
| transporter 550B carrying the first storage | 500A is now in |
| device 500A into the second test slot 310B | another test slot 310. |
| (loading the third storage device 500A). | |

This sequence of automation moves requires only 7 operations, instead of 8, and has the benefit of not requiring an empty test slot 310C, which would be important if the testing system 100 was full.

A number of implementations have been described. Nevertheless, it will be understood that various modifications may be made without departing from the spirit and scope of the disclosure. For example, the test system may incorporate more than one automated transporter. In such a case, the optimizations may be applied to each transporter individually or across both transporters simultaneously. In another example, the storage devices may be presented, transported, or tested in groups of two or more storage devices. In such a case, the optimizations may be applied to groups of more than one storage unit. In another example, the staging slots 311 may be implemented as dedicated slots with no provisions for testing, or may be allocated from currently unused slots or tote locations. Accordingly, other implementations are within the scope of the following claims.

What is claimed is:

1. A method of transferring storage devices within a storage device testing system, the method comprising:
maintaining storage device information of storage devices presented for testing or that have completed some stage of testing;
querying at least one rack having test slots to obtain test slot servicing information;
determining a servicing routine based on the storage device information and the test slot servicing information, the servicing routine comprising storage device transfers for transferring storage devices between first and second locations;
producing a command routine for executing the servicing routine, the command routine comprising a sequence of automation moves for execution by an automated transporter configured to handle one or more storage devices during a single automation move; and
executing the command routine on the automated transporter;
wherein producing the command routine comprises executing at least one of a time-based enhancement and a sequence-based enhancement on the command routine, the time-based enhancement comprising selecting a second automation move based on a start location of the second automation move and an end location of a sequentially preceding first automation move, the sequence-based enhancement comprising producing a reduced sequence of automation moves for one or more storage device transfers.

2. The method of claim 1, wherein executing the time-based enhancement on the command routine further comprises selecting the second automation move based on the travel time of the automated transporter between the start location of the second automation move and the end location of a preceding first automation move.

3. The method of claim 1, wherein executing the time-based enhancement on the command routine further comprises arranging a set of one or more automation moves of a first storage device transfer to be sequentially adjacent a set of one or more automation moves of a second storage device transfer.

4. The method of claim 3, wherein the first storage device transfer comprises moving a first storage device between a first test slot and a first presentation location, and the second storage device transfer comprises moving a second storage device between a second presentation location and a second test slot.

5. The method of claim 4, wherein the first and second test slots are the same test slot.

6. The method of claim 4, wherein the first and second presentation locations are the same presentation location.

7. The method of claim 3, wherein the first storage device transfer comprises moving a first storage device between a first test slot and a second test slot, and the second storage device transfer comprises moving a second storage device between the second test slot and a presentation location.

8. The method of claim 1, wherein executing the sequence-based enhancement on the command routine further comprises producing a fixed sequence of automation moves for a combination of two or more storage device transfers.

9. The method of claim 1, wherein executing the sequence-based enhancement on the command routine further comprises producing a combined automation move that replaces a sequentially first automation move and a sequentially second automation move.

10. The method of claim 9, wherein the sequentially first automation move comprises depositing an empty first storage device transporter and the sequentially second automation move comprises retrieving an empty second storage device transporter for retrieving a storage device, the combined automation move comprises using the first storage device transporter to retrieve the storage device.

11. The method of claim 1, wherein the servicing routine comprises:
a first storage device transfer comprising moving a first storage device between a first test slot and a first presentation location; and
a second storage device transfer comprising moving a second storage device between a second presentation location and a second test slot; and
wherein the sequence-based enhancement of the command routine comprises:
retrieving a storage device transporter carrying the first storage device from the first test slot;
depositing the first storage device at the first presentation location;
retrieving the second storage device from the second presentation location with the empty storage device transporter; and
depositing the storage device transporter carrying the second storage device in the second test slot.

12. The method of claim 11, wherein the first and second test slots are the same test slot.

13. The method of claim 11, wherein the first and second presentation locations are the same presentation location.

14. The method of claim 11, wherein the first and second presentation locations comprise one or more tote receptacles of a tote, wherein each of the tote receptacles is configured to receive a storage device.

15. The method of claim 14, wherein the first and second presentation locations are the same tote receptacle.

16. The method of claim 1, wherein the servicing routine comprises:
a first storage device transfer comprising moving a first storage device between a first test slot and a second test slot;
a second storage device transfer comprising moving a second storage device between the second test slot and a first presentation location; and
a third storage device transfer comprising moving a third storage device from a second presentation location to the first test slot; and
wherein the sequence-based enhancement of the command routine comprises:
retrieving a first storage device transporter carrying the first storage device from the first test slot;
depositing the first storage device at a staging location;
retrieving the third storage device from the second presentation location with the empty first storage device transporter;
depositing the first storage device transporter carrying the third storage device in the first test slot;
retrieving a second storage device transporter carrying the second storage device from the second test slot;
depositing the second storage device at the first presentation location;
retrieving the first storage device from the staging location with the empty second storage device transporter; and
depositing the second storage device transporter carrying the first storage device in the second test slot.

17. The method of claim 16, wherein the first and second presentation locations comprise one or more tote receptacles of a tote, and wherein each of the tote receptacles is configured to receive a storage device.

18. The method of claim 17, wherein the first and second presentation locations are the same tote receptacle.

19. The method of claim 1, wherein the servicing routine comprises:
a first storage device transfer comprising moving a first storage device between a first test slot and a second test slot; and
a second storage device transfer comprising moving a second storage device between the second test slot and a presentation location; and
wherein the sequence-based enhancement of the command routine comprises:
retrieving a first storage device transporter carrying the first storage device from the first test slot;
depositing the first storage device at a staging location;
depositing the empty first storage device transporter in the first test slot;
retrieving a second storage device transporter carrying the second storage device from the second test slot;
depositing the second storage device at the presentation location;
retrieving the first storage device from the staging location with the empty second storage device transporter; and
depositing the second storage device transporter carrying the first storage device in the second test slot.

20. The method of claim 19, wherein the presentation location comprises a tote receptacle configured to receive a storage device.

21. A storage device testing system comprising:
a controller;
an automated transporter in communication with the controller, the automated transporter configured to handle one or more storage devices during a single automation move;
racks arranged for access by the automated transporter;
test slots housed by each rack, each test slot configured to receive a storage device for testing; and
a transfer station arranged for access by the automated transporter, the transfer station presenting storage devices for testing;
wherein the controller is configured to:
receive storage device information of storage devices presented for testing;
query at least one rack to obtain test slot servicing information;
determine a servicing routine based on the storage device information and the test slot servicing information, the servicing routine comprising storage device transfers for transferring storage devices between first and second locations;
produce a command routine for executing the servicing routine, the command routine comprising a sequence of automation moves for execution by the automated transporter; and
execute the command routine on the automated transporter;
wherein producing the command routine comprises executing at least one of a time-based enhancement and a sequence-based enhancement on the command routine, the time-based enhancement comprising selecting a second automation move based on a start location of the second automation move and an end location of a sequentially preceding first automation move, the sequence-based enhancement comprising producing a reduced sequence of automation moves for one or more storage device transfers.

22. The storage device testing system of claim 21, wherein executing the time-based enhancement on the command routine further comprises selecting the second automation move based a travel time of the automated transporter between the start location of the second automation move and the end location of a preceding first automation move.

23. The storage device testing system of claim 21, wherein executing the time-based enhancement on the command routine further comprises arranging a set of one or more automation moves of a first storage device transfer to be sequentially adjacent a set of one or more automation moves of a second storage device transfer.

24. The storage device testing system of claim 23, wherein the first storage device transfer comprises moving a first storage device between a first test slot and a first presentation location, and the second storage device transfer comprises moving a second storage device between a second presentation location and a second test slot.

25. The storage device testing system of claim 24, wherein the first and second test slots are the same test slot.

26. The storage device testing system of claim 24, wherein the first and second presentation locations are the same presentation location.

27. The storage device testing system of claim 23, wherein the first storage device transfer comprises moving a first storage device between a first test slot and a second test slot, and the second storage device transfer comprises moving a second storage device between the second test slot and a presentation location.

28. The storage device testing system of claim 21, wherein executing the sequence-based enhancement on the command routine further comprises producing a fixed sequence of automation moves for a combination of two or more storage device transfers.

29. The storage device testing system of claim 21, wherein executing the sequence-based enhancement on the command routine further comprises producing a combined automation move that replaces a sequentially first automation move and a sequentially second automation move.

30. The storage device testing system of claim 29, wherein the sequentially first automation move comprises depositing an empty first storage device transporter and the sequentially second automation move comprises retrieving an empty second storage device transporter for retrieving a storage device, the combined automation move comprises using the first storage device transporter to retrieve the storage device.

31. The storage device testing system of claim 21, wherein the servicing routine comprises:
a first storage device transfer comprising moving a first storage device between a first test slot and a first presentation location; and
a second storage device transfer comprising moving a second storage device between a second presentation location and a second test slot; and
wherein the sequence-based enhancement of the command routine comprises:
retrieving a storage device transporter carrying the first storage device from the first test slot;
depositing the first storage device at the first presentation location;
retrieving the second storage device from the second presentation location with the empty storage device transporter; and
depositing the storage device transporter carrying the second storage device in the second test slot.

32. The storage device testing system of claim 31, wherein the first and second test slots are the same test slot.

33. The storage device testing system of claim 31, wherein the first and second presentation locations are the same presentation location.

34. The storage device testing system of claim 31, wherein the first and second presentation locations comprise one or more tote receptacles of a tote, and wherein each of the tote receptacles is configured to receive a storage device.

35. The storage device testing system of claim 34, wherein the first and second presentation locations are the same tote receptacle.

36. The storage device testing system of claim 21, wherein the servicing routine comprises:
a first storage device transfer comprising moving a first storage device between a first test slot and a second test slot;
a second storage device transfer comprising moving a second storage device between the second test slot and a first presentation location; and
a third storage device transfer comprising moving a third storage device from a second presentation location to the first test slot; and
wherein the sequence-based enhancement of the command routine comprises:
retrieving a first storage device transporter carrying the first storage device from the first test slot;
depositing the first storage device at a staging location;
retrieving the third storage device from the second presentation location with the empty first storage device transporter;
depositing the first storage device transporter carrying the third storage device in the first test slot;
retrieving a second storage device transporter carrying the second storage device from the second test slot;
depositing the second storage device at the first presentation location;
retrieving the first storage device from the staging location with the empty second storage device transporter; and
depositing the second storage device transporter carrying the first storage device in the second test slot.

37. The storage device testing system of claim 36, wherein the first and second presentation locations comprise one or more tote receptacles of a tote, and wherein each of the tote receptacles is configured to receive a storage device.

38. The storage device testing system of claim 37, wherein the first and second presentation locations are the same tote receptacle.

39. The storage device testing system of claim 21, wherein the servicing routine comprises:
a first storage device transfer comprising moving a first storage device between a first test slot and a second test slot; and
a second storage device transfer comprising moving a second storage device between the second test slot and a presentation location; and
wherein the sequence-based enhancement of the command routine comprises:
retrieving a first storage device transporter carrying the first storage device from the first test slot;
depositing the first storage device at a staging location;
depositing the empty first storage device transporter in the first test slot;
retrieving a second storage device transporter carrying the second storage device from the second test slot;
depositing the second storage device at the presentation location;
retrieving the first storage device from the staging location with the empty second storage device transporter; and
depositing the second storage device transporter carrying the first storage device in the second test slot.

40. The storage device testing system of claim 39, wherein the presentation location is a tote receptacle of a tote, and wherein the tote receptacle is configured to receive a storage device.
